(19) United States
(12) Patent Application Publication
(10) Pub. No.: US 2013/0325787 A1
(43) Pub. Date: Dec. 5, 2013

(54) Temporal Predictive Analytics

(71) Applicant: Intelligent Software Solutions, Inc., Colorado Springs, CO (US)

(72) Inventors: Mark Gerken, Colorado Springs, CO (US); Rick Pavlik, (US); Kevin Daly, Colorado Springs, CO (US)

(21) Appl. No.: 13/906,101

(22) Filed: May 30, 2013

Related U.S. Application Data
(60) Provisional application No. 61/655,407, filed on Jun. 4, 2012.

(51) Int. Cl. G06N 5/04

(52) U.S. Cl. CPC G06N 5/048
USPC 706/52

(57) ABSTRACT

A fuzzy complex event processing (CEP) system successfully processing noisy, incomplete, multi-source data in support of near real-time decision-making. The fuzzy CEP solution of the present invention supports decision-making by identifying and exploiting patterns hidden in complex data and can operate in a forensic mode against historical data, near real-time mode for proactive decision-making, or any combination thereof. Fusion algorithms and techniques are applied to observation data that may only partially satisfy an event description in time, space, or other relevant dimensions. Using context propagation, Bayesian reasoning, and spatiotemporal analysis, the present invention provides both predictive awareness of upcoming events and likelihood analysis for events that may have already occurred, but were not evident in the collected data, while at the same time minimizing false detections.

### RELATED APPLICATION

The present application relates to and claims the benefit of priority to U.S. Provisional Patent Application No. 61/655,407 filed 4 Jun. 2012, which is hereby incorporated by reference in its entirety for all purposes as if fully set forth herein.

### STATEMENT REGARDING FEDERAL SPONSORED RESEARCH OR DEVELOPMENT

The U.S. Government has a paid-up license to portions of this invention and the right, in limited circumstances, to require the patent owner to license others on reasonable terms as provided for by the terms of contract FA8750-11-C-0174 and FA8750-07-C-0068 awarded by the United States Air Force.

### BACKGROUND OF THE INVENTION

1. Field of the Invention

The present invention relates in general to Complex Event Processing and more particularly to fuzzy, probabilistic, and semantic temporal situational exploitation of Complex Event Processing.

2. Relevant Background

Decision-makers are often swimming in sensors and drowning in data. Complicating this fact is that data is often incomplete, inaccurate, or simply missing. As a result, much of this data simply “falls to the floor,” never to be seen or analyzed by those for whom the data was collected. Organizations collect data in an attempt to understand the environment in which they operate and to support intelligent and timely decision-making. As implied above, for many of these organizations, the ability to collect these data far exceeds their ability to process it. Large amounts of data are collected, sometimes on the order of thousands of datums per second, but relatively few resources are available to make sense of it all.

To combat this problem, various efforts have been undertaken to extract meaningful events from this ocean of data and from those events extract or discern important information and trends to include forecasting upcoming events based on what has been extracted to that point. Collectively referred to as Complex Event Processing (CEP), this branch of artificial intelligence (AI) research has focused on the development of tools and techniques that can effectively recognize and extract events across heterogeneous data to provide alerting and predictive assessment so that analysts can focus on those data that are most relevant to their mission and situation.

Complex Event Processing involves searching through or monitoring data sources/feeds for various events of interest. A commonly used definition of an event is “something that happens.” Such a definition raises many question about the role of time in this definition. For example, is time discrete or continuous? Can two events happen at the same time or not? etc. The present invention does not attempt to address this as such discussions are outside the scope of this application. Instead, we will take the definition at face value and defer discussions on the granularity of time to other researchers. Accordingly a car entering a parking lot, a bank transaction, and an email arriving in your in-box are all examples of events under this definition. It also follows that a complex event is an event involving multiple constraints and which may involve multiple entities or actors. For example, a convoy containing a large fueling truck leaving a named area of interest (AOI) under cover of darkness may be a complex event: constraints are levied on the convoy composition (it must include a large fuel truck), activity (leaving a named AOI), and environmental conditions (darkness). Bringing it all together, complex event processing involves detecting and processing complex events, generally in support of information discovery and decision support.

A challenge exists to identify and understand relevant data amid a plethora of information. Moreover, a need exists for the ability to consider and understand the reliability and accuracy of the data when making decisions as to its relevancy. These and other deficiencies of the prior art are addressed by one or more embodiments of the present invention.

### SUMMARY OF THE INVENTION

One or more embodiments of the present invention provide a fuzzy complex event processing (CEP) system that can successfully process noisy, incomplete, multi-source data in support of near real-time decision-making. The present invention's fuzzy CEP solution is designed to support decision-making by identifying and exploiting patterns hidden in complex data. One or more embodiments of the present invention can operate in a forensic mode against historical data, near real-time mode for proactive decision-making, or any combination thereof. The present invention makes use of advanced fuzzy information fusion algorithms and techniques to successfully use observation data that may only partially satisfy any event description in time, space, or other relevant dimensions. Through the use of sophisticated context propagation, Bayesian reasoning, and spatiotemporal analysis, the present invention provides both predictive awareness of upcoming events and likelihood analysis for events that may have already occurred, but were not evident in the collected data, while at the same time minimizing false detections. In other aspects of the present invention, custom rules and logic sets can be associated with unique models and executed against data matched against a model's event description.

One or more embodiments of the present invention provide near real-time assessment of data as it is being recorded. The present invention can support a wide range of model complexity and monitor data sources for particular updates, events of interest in a geographic region, or complex multi-event models describing a complex interaction of entities over space and time. Moreover, embodiments presented herein are customizable, allowing for quick visualization of data matched against a particular model.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 is a high level block diagram showing the four contributory features of a system for temporal predictive analytics according to one embodiment of the present invention;

FIG. 2A presents, according to one embodiment of the present invention, a high level view of an activity model;

FIG. 2B is an enhanced view of one node or event of the activity model shown in FIG. 2A;

FIG. 2C presents, according to one embodiment of the present invention, another activity model for temporal predictive analytics;

FIG. 3 shows an example of a event or evidence description, according to one embodiment of the present invention, regarding data pertaining to a particular event associated with one or more models;

FIG. 4 is, according to one embodiment of the present invention, a Semantic Web Structure depicting data pedigree/provenance and confidence;

FIG. 5 is a high level block diagram of one embodiment of literature based discovery according to the present invention;

FIG. 6 presents a graphical depiction of a relative temporal constraint according to one embodiment of the present invention;

FIG. 7 is an overhead image of a relative spatial constraint according to one embodiment of the present invention; and

FIG. 8 is a flowchart of one method embodiment for temporal predictive analytics according to the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

Disclosed hereafter by way of example is a system for Temporal “Fuzzy” Complex Event Processing. One or more embodiments of the present invention identifies and exploits hidden patterns in complex data to provide predictive analysis of select events. The present invention is not constrained to perform exact matches when comparing data in time and space and, by doing so, the present invention enables users to make sense of complex data sets that may include data from disparate sources.

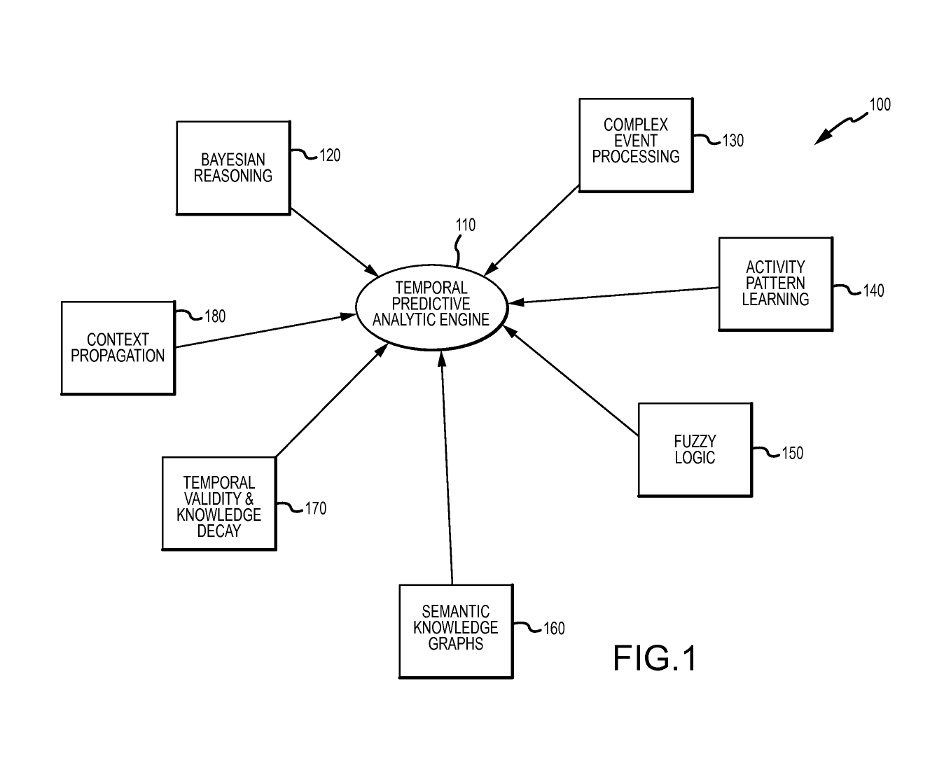

FIG. 1 provides one embodiment of a high level depiction of the components of a predictive situational awareness system 100 of the present invention. A temporal predictive analytic engine 110 gains and processes information from a variety of sources including Bayesian Reasoning 120, Complex Event Processing 130, Activity Pattern Leaning 140, Fuzzy Logic 150, Semantic Knowledge Graphs 160, Temporal Validity & Knowledge Decay 170 and Context Propagation 180.

One or more embodiments of the present invention provide a means to create and represent models or activity patterns that use a variety of event probabilistic representations including complex probabilistic algorithms or simplistic confidence increments or factors when reasoning event states. Accordingly, the assessment strategy may, in one embodiment, be probability based, while in another embodiment, confidence increment based. In each case, temporal factors can be represented to provide a unique understanding and valuation of an event. Moreover, confidence of the data, or an assessment of the data, can be included in the model. Each event state can have a confidence or probability associated with it to assist in the determination of a total confidence of the model assessment.

Another aspect of the present invention is probability based reasoning using Bayesian algorithms to calculate probabilities of each state transition wherein the probability is based on the observation status (either success (true state), unobserved (unknown state) or failure (false state)) of that node's parent or ancestor states. In other embodiments, confidence increment reasoning sums each event state's confidence and presents a confidence number for the overall success of the model.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter. Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

Complex Event Processing (CEP) is a method of tracking and analyzing (processing) streams of information (data) about things that happen (events), and deriving a conclusion from those events. Complex event processing, or CEP, is event processing that combines data from multiple sources to infer events or patterns that suggest more complicated circumstances. The goal of complex event processing is to identify meaningful events (such as opportunities or threats) and respond to them as quickly as possible.

These events may be happening across the various layers of an organization as sales leads, orders, or customer service calls. Alternatively, they may be or may be derived from news items, text messages, social media posts, stock market feeds, traffic reports, weather reports, or other kinds of data. An event may also be defined as a “change of state,” when a measurement exceeds a predefined threshold of time, temperature, or other value. CEP solutions can provide insight into business operations by running query analysis against live feeds and event data. These solutions can, in one embodiment of the present invention, use real-time data to collect and correlate against historical data to provide insight into and analysis of the current situation. Multiple sources of data can be combined from different organizational silos to provide a common operating picture that uses current information.

A Directed Acyclic Graph (DAG) is a directed graph with no directed cycles. That is, it is formed by a collection of vertices (nodes) and directed edges, each edge connecting one vertex to another, such that there is no way to start at some vertex v and follow a sequence of edges that eventually loops back to v again.

With respect to the present invention, a DAG is a collection of tasks that must be ordered into a sequence, subject to constraints that certain tasks must be performed earlier than others, with algorithms or similar ordering constraints used to generate a valid sequence. In mathematical parlance, the ordering may be partial rather than total. For example, we could have a requirement that event A occur before either event B or C, and that either event B or C occur before event D, but there is no temporal ordering required between events B and C. We could have B then C, C then B, B in isolation, or C in isolation.

Fuzzy logic is a form of many-valued logic or probabilistic logic; it deals with reasoning that is approximate rather than fixed and exact. Compared to traditional binary sets (where variables may take on true or false values) fuzzy logic variables may have a truth value that ranges in degree between 0 and 1 inclusively. Fuzzy logic has been extended to handle the concept of partial truth, where the truth value may range between completely true and completely false. Furthermore, when linguistic variables are used, these degrees may be managed by specific functions.

Bayesian reasoning or probability is one of many interpretations of the concept of probability belonging to the category of evidential probabilities. The Bayesian interpretation of probability can be seen as an extension of the branch of mathematical logic known as propositional logic that enables reasoning with propositions whose truth or falsity is uncertain. To evaluate the probability of a hypothesis, the Bayesian probabilist specifies some prior probability, which is then updated in the light of new, relevant data.

The Bayesian interpretation provides a standard set of procedures and formulae to perform this calculation. Bayesian probability interprets the concept of probability as “an abstract concept, a quantity that we assign theoretically, for the purpose of representing a state of knowledge, or that we calculate from previously assigned probabilities,” in contrast to interpreting it as a frequency or “propensity” of some phenomenon.

Broadly speaking, there are two views on Bayesian probability that interpret the probability concept in different ways. According to the objectivist view, the rules of Bayesian statistics can be justified by requirements of rationality and consistency and interpreted as an extension of logic. According to the subjectivist view, probability quantifies a “personal belief.”

An Open World Assumption is the assumption that the truth-value of a statement is independent of whether or not it is known by any single observer or agent to be true. It is the opposite of the closed world assumption, which holds that any statement that is not known to be true is false. The open world assumption (OWA) is used in knowledge representation to codify the informal notion that in general no single agent or observer has complete knowledge, and therefore cannot make the closed world assumption. The OWA limits the kinds of inference and deductions an agent can make to those that follow from statements that are known to the agent to be true. In contrast, the closed world assumption allows an agent to infer, from its lack of knowledge of a statement being true, anything that follows from that statement being false.

Heuristically, the open world assumption applies when we represent knowledge within a system as we discover it, and where we cannot guarantee that we have discovered or will discover complete information. In the OWA, statements about knowledge that are not included in or inferred from the knowledge explicitly recorded in the system may be considered unknown, rather than wrong or false. By comparison many procedural programming languages and databases make the closed world assumption. For example, if a typical airline database does not contain a seat assignment for a traveler, it means the traveler has not checked in. The closed world assumption typically applies when a system has complete control over information; this is the case with many database applications where the database transaction system acts as a central broker and arbiter of concurrent requests by multiple independent clients (e.g., airline booking agents). There are however, many databases with incomplete information: one cannot assume that because there is no mention on a patient's history of a particular allergy, that the patient does not suffer from that allergy.

By the term “substantially” it is meant that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with, or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation, in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words,” or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

CEP systems have been designed and developed to combat data overload: their primary purpose is to use computer technology to sift through myriads of observation data in search of those data that are relevant to a given decision-maker in a given context. It is important to note that relevancy is dependent on both the decision-maker and their context. For example, consider a large shipping corporation charged with picking up, transporting, tracking, and delivering a wide variety of goods. Decision-makers in different departments within this company will very likely have different but related responsibilities. Some may be responsible for tracking the health and status of their delivery fleet while others may be responsible for tracking order processing and delivery status for packages within their geographic regions (if organized geographically) or for tracking packages based on the type of vehicle used (e.g., air or ground). The data needed to support these decision-makers is very likely to differ based on their areas of responsibilities. Context also plays an important role. Within this hypothetical company, data needs within a given department such as vehicle maintenance are likely to differ based on context. Personnel charged with forecasting fuel needs and costs are likely to require much different data than those charged with forecasting maintenance costs and schedules or for forecasting vehicle retirements and acquisitions. Various CEP models can and have been designed to support these types of tasks. CEP models have been developed and used to support a variety of data intensive tasks ranging from watching data streams for messages matching specific criteria to detecting relatively complex event patterns associated with activities of interest such as detecting bank fraud.

To address these different data needs, CEP systems typically support multiple models that can operate either cooperatively or in isolation. Data appropriate to a given model, such as one designed to detect potential fraudulent bank transactions, are processed by those models while other data irrelevant to those models are ignored. Relatively large volumes of data can be processed by these engines, freeing analysts and decision-makers to focus on the task of interpreting and acting on important information rather than searching for data relevant to their domains. Another important role played by CEP systems is one that can be viewed as a relatively long term standing query. In contrast to database queries such as retrieving a customer record, a long term standing query typically searches for data associated with the occurrence of an event of interest over an extended period of time, such as finding data that provides evidence of a fraudulent bank transaction.

While specifics vary from one implementation to another, CEP systems describe events using some sort of event description language. These languages vary in complexity and expressiveness but generally provide support for describing events of interest within a given domain and provide support for defining assemblies of events or event sequences/patterns. Given a description of an event or an event sequence, a CEP engine will—depending on configuration—either search for or begin watching for data that matches the event descriptions. As matching data is found, it is “fused” against the event description and, depending on the specifics of the associated model and configuration of the engine, the engine may issue alerts and notifications and make those data available to analysts in support of their decision-making processes.

### Common Features

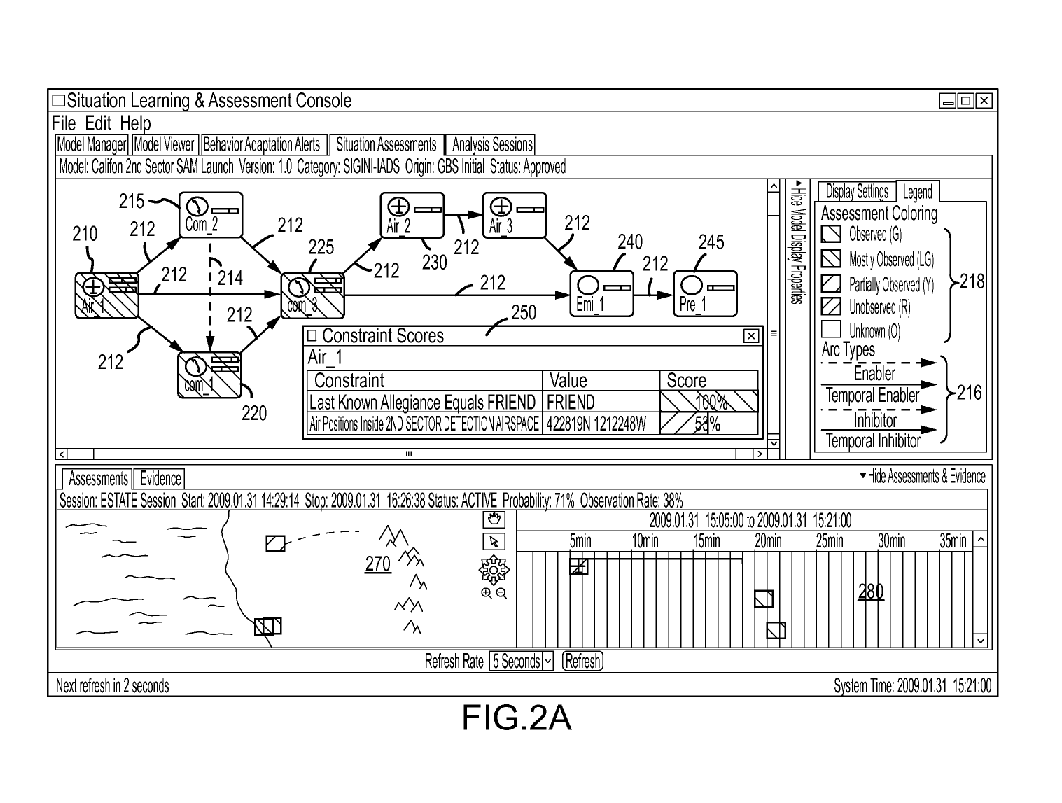

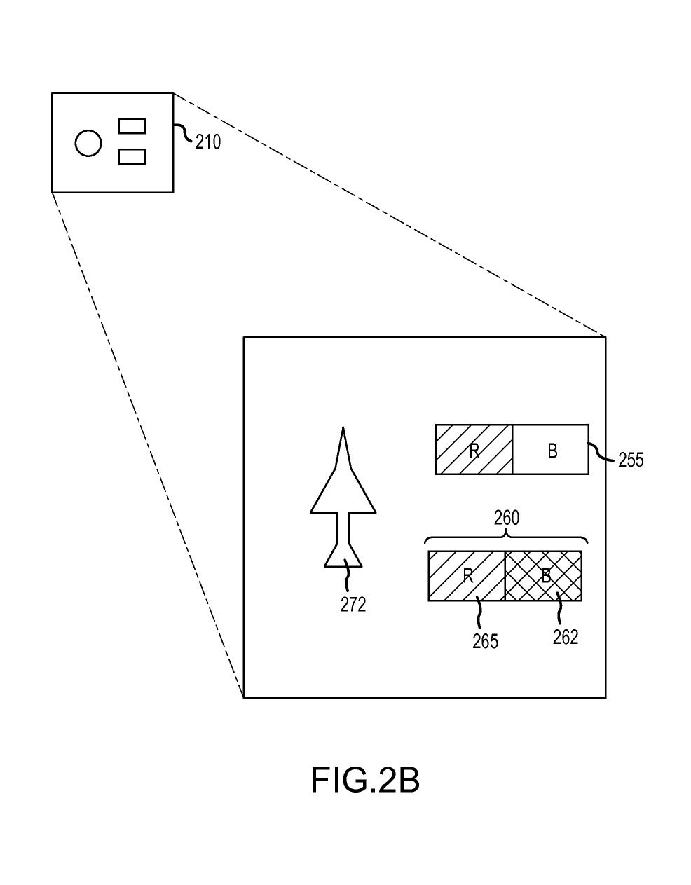

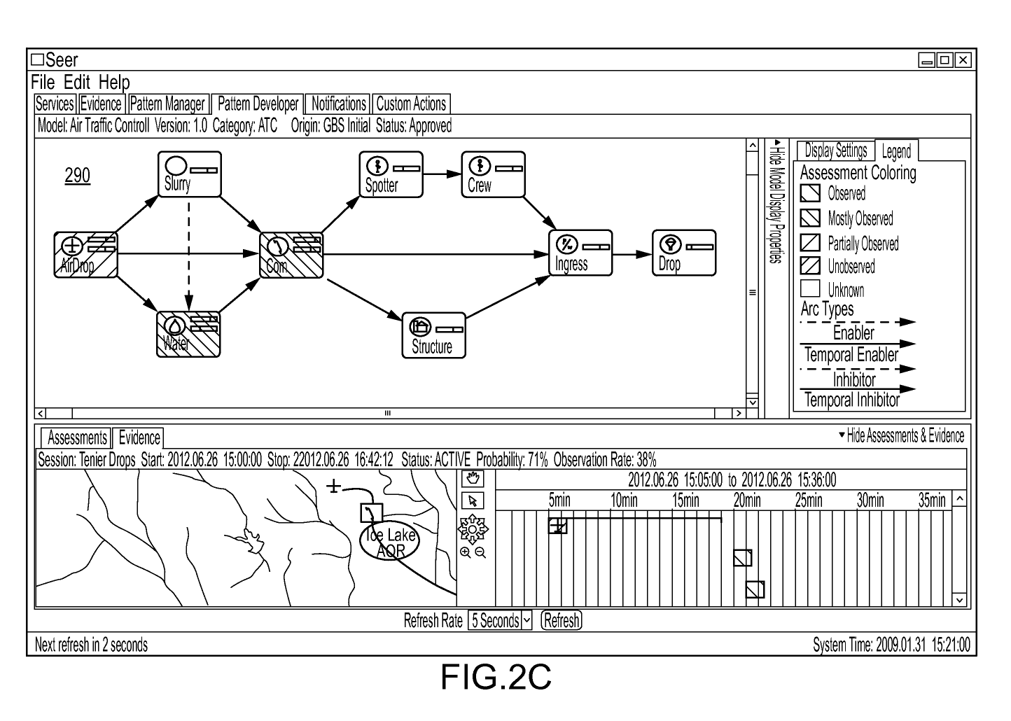

Considering the above description, several salient features common across CEP systems of the present invention can be identified:
Event Description. CEP systems of the present invention include a method for describing events and for assembling event descriptions into more complex event patterns. However, syntax and expressiveness varies across solutions. A sample event model according to the present invention is shown in FIG. 2A.
Fusion. The CEP system of the present invention includes a method of fusing observation data against event descriptions. Most CEP engines of the prior art use “crisp” fusion meaning that only those data that precisely match an event description may be successfully fused against it. As described below, the CEP of the present invention uses a form of Fuzzy Fusion in which observation data that is “close” to that which was expected may be successfully matched against an event description.
Notification. CEP systems are useless if they are unable to issue alerts and/or notifications when they find data that can be successfully fused against an event model. While the specifics of notification mechanisms vary, many provide support for executing additional business rules using the data fused against a given event model. The CEP system of the present invention provides support for notification as well as support for executing custom business rules through the use of Groovy Scripts or similar object-oriented programming language which may be attached to an event model.

### Concept of Operations

Before delving into the specific applications of the present invention and its unique features, it may be worthwhile to briefly describe the overall architecture and design of the CEP system of the present invention. The present invention is a CEP engine designed to support predictive situation awareness. When used in this manner, the present invention matches or fuse observation data against event descriptions within an activity model to provide analysts and decision-makers insight into unfolding situations of interest. As part of this process, the present invention, in one embodiment, uses Bayesian Reasoning and Fuzzy Logic to support predictive analytics in the form of likelihood computations for as-yet unobserved events. Because many of the domains for which the present invention was developed include behaviors or situations of interest that span time and space, temporal and spatial reasoning is also supported. A byproduct of its temporal reasoning capability is that the present invention can be configured to run in a historical mode in support of model validation, forensic analysis, or similar use cases; a combination of historical mode and near real-time mode; or in near real-time mode. Note that the CEP engines of the prior art are by their nature not real-time as they operate against recorded data.

As evidence (data) is fused against the present invention models, users are given the opportunity to view that evidence using a variety of data appropriate displays including tables, maps, and timelines. While fully capable to support predictive awareness, the present invention can also support a forensic mode of operation in which an event of interest such as an equipment failure, is used to trigger an attributive mode of operation in which the most plausible explanation for the event is determined from among a collection of possible explanations. In other embodiments, the present invention can operate against graph-based data structures.

Another feature of the present invention is that it is designed to support domains with data that may be noisy, uncertain, or missing. (Of course it also works well in domains with clean data.) Operation in these domains is associated with several important design features that are reflected in the various embodiments of the present invention. As mentioned above, the present invention equally supports forensic analysis (e.g., determining the most likely explanation for an observation), as well as to non-predictive but useful CEP tasks such as persistent, fuzzy queries and providing simple area of interest (AOI) monitoring. The latter two used cases typically involve relatively simple, one-state models, while predictive situation awareness (or proactive decision support) and forensic analysis typically involve more complex, multi-state models. These can include:
Application domains and the Open World assumption;
the present invention model structure; and
Model activation.

### Application Domains.

Another significant aspect of the present invention is that it is designed to support domains in which observation data may be uncertain, such as those associated with military operations. There are several sources for this uncertainty, including sensor capability and configuration, sensor network coverage, environmental conditions, user interaction, and Camouflage, Concealment and Deception (CCD) activities by those entities being observed, and the like. To address uncertainty with respect to the sensor network and sensor status, two general approaches are considered with respect to sensor suite knowledge.

### Sensor Suite Knowledge.

Under one approach, the present invention gains access to the sensor network status, configuration, and collection plan to help resolve questions surrounding missing observations. The process works as follows: given that the sensor platform was properly configured and positioned, the lack of an observation corresponding to an event in question could be taken to mean that the event did not occur provided the entity being observed was not engaging in CCD activities. However, this CCD assumption is invalid in many domains, so knowledge of the sensor network and collection activities alone may not be able to fully resolve questions surrounding unobserved events.

The present invention uses an open world assumption, meaning the lack of an observation does not imply that the event in question did not occur. Under this assumption, the event may have occurred but the sensor network may not have been properly configured or positioned to observe that event or the entity being observed may have success fully engaged in CCD activities.

Because access to sensor suite knowledge cannot be universally guaranteed, the present invention further supports operations in which knowledge of the sensor network and sensor status/configuration(s) is unknown. Again, an open world assumption is adopted: the lack of observation data (generally) conveys no information as to the occurrence or nonoccurrence of an event. The present invention also supports event descriptions characterized by a lack of matching observation data, such as event descriptions designed to detect late report filings; events in question may have occurred but the sensor suite failed to detect evidence of it. To support event processing under this assumption, two important capabilities have been folded into the present invention: node skipping and partial correlation.

### Node Skipping.

One aspect of the present invention is its ability to allow observation data to be fused against any node (event) in an activity model, provided temporal or contextual constraints for that node have been satisfied. As an example, the present invention event descriptions may contain constraints expressing relative temporal offsets from other events in the model, as in “event C should occur 60 to 90 minutes after event B and B should occur 10 to 15 minutes after event A.” In such cases, data may be fused against event C when it becomes temporally plausible for event C to be observed given the model and observation data to that point (e.g., 70 to 105 minutes after event A).

### Partial Correlation of Evidence (Fuzzy Fusion).

The present invention also supports partial evidence correlation in which observation data that partially matches an event description may be used to update the model. This process is described in further detail in a subsequent section of this document.

Through both partial evidence correlation and correlation of evidence against any temporally plausible node, missing or incomplete observations do not, according to the present invention, disrupt event processing. Indeed, as observation data (or evidence) is fused against downstream nodes in the network, the probability values for unobserved or partially observed upstream nodes are updated using Bayesian propagation. Postmortem analysis on the activity model and observation data can reveal potential problems with the sensor network, uncover likely CCD activities, or reveal the need to adapt the activity model in the face of new or modified entity behaviors.

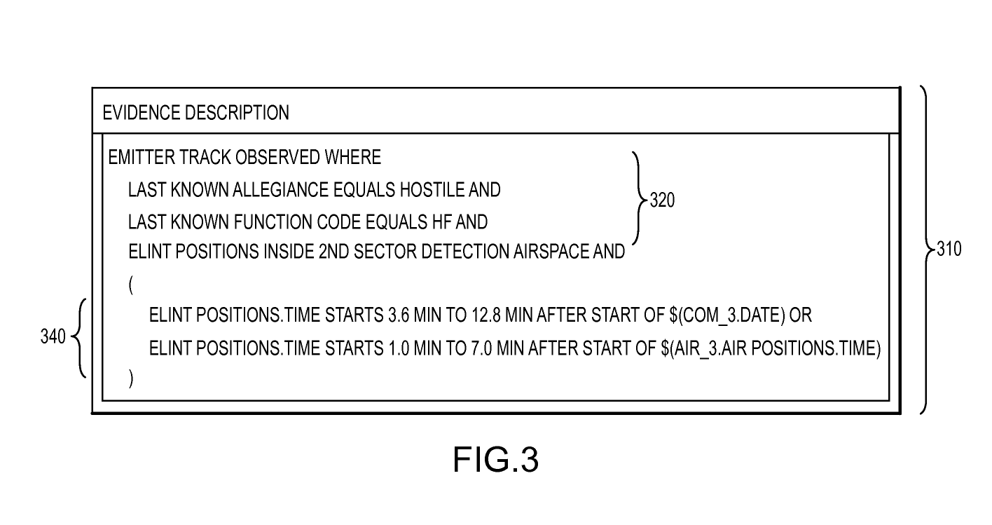

To better understand the various embodiments of the present invention consider the following model structure. FIG. 2A presents, according to one embodiment of the present invention, a high level view of an activity model drawn from the Integrated Air Defense System (IRDS) domain. This activity model was designed to support prediction of surface-to-air missile (SAM) launches and was developed using synthetic data (data generated using a modeling system designed to mimic real-world scenarios). As can be seen in FIG. 2, the present invention models are graphical in nature, forming a directed acyclic graph (DAG). The present model (also referred to herein as an activity pattern) is comprised of eight (8) nodes 210, 215, 220, 225, 230, 235, 240, 245. Each node in the graph represents an event or evidence description similar to that of FIG. 3 whose occurrence is part of the behavior being modeled by this activity pattern. In the case of the IRDS model, several events (nodes) are shown leading to an eventual surface-to-air missile (SAM) launch that is represented by the last event 245. The creation of the model or the activity pattern can be based on historical data or can be learned by establishing an event query and having the present invention develop a corresponding collection of events that would be representative of the event in question. In this example, according to one embodiment, an analyst could manually create the pattern flow of events based on his or her analysis of historical data or personal experience. In this case the individual may understand what chain of events must occur for a surface-to-air missile to be launched and develop the model accordingly. In another embodiment of the present invention the analyst may enter the end query, that is, the launch of a surface-to-air missile, and let the system example historical data to autonomously develop the underlying activity plan.

Continuing with reference to FIG. 2A, while not explicitly shown in this figure, the initiating event can be the detection of a blue aircraft penetrating into the red air defense zone. Arrows between each node events 212, 214 represent at a minimum a statistical correlation between the parent at the head of the arrow and the child at the tail of the arrow. The arrows can represent various relations as shown in the legend 216. For example the first node 210 temporally enables 212 the second, third and fourth node 215, 220, 225. However the second node 215 inhibits 214 the third node 220, meaning that if the second event occurs as represented by the second node 220, it's occurrence means that occurrence of node 220 is much less likely to be observed. If temporal constraints are included in the model as they are with the IRDS model of FIG. 2, these arrows represent a form of Granger Causality indicating both a temporal and a statistical correlation between the associated events. As one of reasonable skill in the relevant art will appreciate, other causal relationships can be depicted by the DAG and incorporated into the model.

Each node can also be colored or otherwise modified to represent the status of an event as indicated in the upper legend 218. In this example the first node (Air_{—}1) 210 has been mostly observed, node 3 (Comm_{—}1) 220 has been observed as has node 4 (Comm_{—}3) 225. However, the other nodes including node 2 (Comm_{—}2) 215 have not been observed. The coding of each node indicates the relative degree to which observation data has been fused against this model's event descriptions. In this case green (G) indicates observed (P (event occurrence|evidence)≧80%), light green (LG) is mostly observed (P (event occurrence|evidence)≧60%), yellow (Y) is partially observed (P (event occurrence|evidence)≧40%), red is unobserved and orange (O) is unknown. A secondary indication of the observation is shown by a bar graph in the upper right corner of the node 255. The bar graphically indicates whether data has been observed, mostly observed, or partially observed. No bar is present if the event is unobserved or unknown. In the model shown in FIG. 2 three nodes Air_{—}1 210, Comm_{—}1 220 and Comm_{—}3 225 provide an indication of data observations. As is further described with reference to FIG. 2A, the observation representation is determined by a constraint score 250. In the case of Air_{—}1 210, two example constraints are listed with an OR conjunction. In this case the first constraint “allegiance equals friend” is 100% satisfied. The second constraint of “2nd Sector Detection Airspace” is only partially satisfied leading to a conclusion that the constraints indicate a ≧60% likelihood the events have occurred rendering the node partially observed or Yellow.

Another feature of the present invention is the application of temporal constraints on the each event in the model. The use of temporal constraints implies the existence of temporal windows during which a model's events are expected to occur. Only those observation data falling within an open temporal window for an event description may be fused against that event description. An event description's temporal windows are closed if, given the observation data fused against the model, the timeframe(s) during which the event was expected to be observed has passed. So for this example, upon detection of an aircraft within a specific airspace, the model for a surface-to-air missile launch may require that a communication be received within 1 minute. This may be a temporal constraint for the next event. Continuing, if P (event occurrence|evidence)<40% and the temporal window(s) for that event has (have) closed, then the event is marked as unobserved. FIG. 2B presents an enlarged view of the representation of the first node 210 (Air_{—}1). The status of temporal windows for this model's event descriptions are shown using a bar 260 displayed in the upper right portion of each event model. Bars that are red (R) 265 and blue (B) 262 indicate the temporal window(s) for those event descriptions have closed but that a short latency period for late reporting data is still open. During this latency period, late reported observation data that would have fallen into an open temporal window for that event may still be fused against that event description. Blue and gray bars provide a visual depiction of open temporal windows that, as the blue portion extends across the bar, are closing. Finally, each node in the graph has a small circular icon insert indicating the type of event 272 expected (e.g., an air track, a communication event, etc.).

The Integrated Air Defense System model shown in FIG. 2A represents an active state of evaluation by one embodiment of the present invention. In this view, observation data fused against the model is shown on a map display 270 depicting the location(s) of observed events; a timeline display 280 for these data is also shown giving the use a temporal relationship to the activity plan. Although not shown, the map display may include topographic or satellite image data. While these depictions are information to an IRDS application of the present invention, other depiction convey similar evidentiary relationships. The screen shot shown in FIG. 2A is a model that actively support increased situational awareness of an upcoming launch of a surface-to-air missile. As one of reasonable skill in the relevant art can appreciate the ideas of the present invention can be applied across a diverse set of activities and queries.

FIG. 2C, for example, provides another activity model for consideration. In this model 290 the temporal predictive analytics of the present invention are applied to fighting a forest fire. In this example, a prediction is being made with respect to an airdrop of water or fire retardant. For example, a need may exist to check for fire crews within an extended boundary of an active forest fire and predict the need for a lifesaving air drop should local weather indicated that the fire is, or will, push toward their area of operations and/or there is dense smoke that will obscure their area of operation.

The activity model shown in FIG. 2C provides nine (9) events that may occur over a 20-30 minute time period in which a correlation between the location in which a fire crew is operating and an evolving weather pattern results in an airdrop. Significantly, one aspect of the present invention is to modify the activity model based on a learning indicator. In this instance, the systems is operable to determine whether there are numerous indications of false positive conclusions or false negative conclusions at each event or within the model as a whole and adjust the system accordingly. The system evaluates the evidence description of each node and the success of the model to provide reliable and useful predictive analytics to the user. In a similar manner the systems of the present invention can be applied to maintenance processes in order to predict mechanical failure of key components. In other implementation of the present invention, an activity model is generated to predict transmission failure of ore trucks used in mining. In this application the mechanical failure of an ore truck at a critical location can severely hamper operations. Thus, is it important to do preventive maintenance and remove the truck from operation before it breaks down. Based on a combination of sensor data such as wheel slip, high RPMs, carry weight, oil temperature and more, the stress on the transmission can be determined so as to predict, very accurately, when the transmission will fail. As a result the present invention can alert a user that a certain vehicle has impending transmission failure and should be removed from the active operations.

Financial transactions are yet another implementation of the predictive temporal analytics of the present invention. Credit card fraud, insider trading, and other fraudulent manipulation of the financial markets can be predicted by the present invention, hopefully before they result in significant financial hardship. Just as with predicting the need for an airdrop to assist firefighters or the failure of a transmission of an ore truck, the present invention can establish an activity model that would suggest a fraudulent transaction has occurred or that a credit card should be frozen. Each node may represent various temporal conditional evidentiary questions that lead to a particular confidence that an event has been observed. For example, the use of the same credit card at two locations, several miles apart within a time period during which relocation is physically improbable. These and other implementations of a system for temporal predictive analytics are applicable and indeed contemplated as being within the scope of the present invention.

With an understanding of an overall activity plan (model) and how it provides a predictive situational awareness, attention is turned to the composition and construction of each observed event (nodes). As mentioned in the example shown in FIG. 2A, each node 210, 215, 220, 225, 230, 235, 240, 245 represents an event. The event can, in one embodiment of the present invention, be described as an evidence description. FIG. 3 is an exemplary evidence description 310 for the Air_{—}1 node 210 of the model shown in FIG. 2. The evidence description includes, according to one embodiment of the present invention, collected sensor data constraints 320 and temporal constraints 340. As one of reasonable skill in the relevant art will appreciate, other evidentiary conditions can be crafted as necessary. Recall the trigger for this model was the detection of aircraft penetrating into a particular air defense zone. For the Air_{—}1 event to be observed, the allegiance of the aircraft must be hostile AND a function code (presumably of the detection device) must equal HF (providing a level of confidence as to the reliability of the track or in this case the output of a high finder system) AND ELINT or a secondary location detection means must place the detected aircraft within the 2nd sector detection airspace. If all three of these data collection inquires are satisfied the evidence pattern looks to two temporal qualifiers 340. In this case the ELINT must occur between 3.6 and 12.8 minutes of a COM_{—}3 event OR occur between 1.0 and 7.0 minutes of a AIR 3 event. Based on this evidence description the event known as Air_{—}1 can be observed triggering the other relational steps in this IRDS model.

As described above, each node in an activity model represents an event in the selected domain. These event models may be defined as a collection of contextual, spatial, and/or temporal constraints expressed in conjunctive normal form. The event shown in FIG. 3 is expressed in Web Enabled Temporal Analysis System's (WebTAS) semi-natural language (SNL). This event model 310 contains two crisp (non-fuzzy) attribute-value pairs (hostile allegiance and a height-finder function code), a fuzzy spatial constraint of being inside the 2nd Sector Airspace 320, and a disjunction of two fuzzy temporal constraints 340 each of which includes an evidence variable whose values are established by ancestor nodes in the network. Although these constraints refer to temporal attributes, other attribute types may also use evidence variables as well. Although not shown in this example, the present invention event models may also contain fuzzy attribute-value constraints. One aspect of the present invention extends and generalizes this approach to use a measure of semantic distance and to replace the semi-natural language event descriptions with a general purpose constraint language supporting a variety of target data forms, including data represented using relational databases or data represented using Semantic Web technology.

Another aspect of the present invention is the ability of maintaining and using multiple activity models simultaneously, not all of which need to be in service at any given time. A model manager component organizes and manages the lifecycle of the models of the present invention. Through this manager, models may be created and approved for service, refined/updated, cloned, retired, or reactivated out of retirement as needed. Once a model has been approved, it may be activated at any time through a model activation dialog. Model activation is a four step process:

Model selection. The model of interest is selected from those in active service. Note that models may be in revision or development (editing mode), in pending status indicating editing is complete but the model has not yet been approved for service, in active service, and retired.

Timeframe identification. A temporal mode of operation is selected. In one embodiment of the present invention, models may be run historically, in near real-time, or some combination thereof.

Location of interest. A geo-spatial or similar area of interest can be identified. If such a constraint is indicated, only those data from that region or regions will be fused against the model.

Notification mechanism/business rule application. The final step in the process is to identify a notification strategy or identify any custom business rules that should be run in case a sufficient corpus of observation data is successfully fused against the model. That is, given a model and evidence, these rules will be executed when the measured probability that the activity being modeled is occurring (or has occurred if in historical mode) exceeds a user specified threshold: P(activity|model, evidence)>threshold. In one implementation of the present invention, Groovy is used to support notifications, alerting, and any other custom business rules.

The present invention offers a unique combination of fuzzy fusion, context propagation, uncertainty management, and the sophisticated treatment of time in a Semantic Web framework. In contrast to most CEP engines, the present invention supports the fusion of observation data that may only partially match an event description. Specifically, through the use of Fuzzy Logic observation data that may only be “close” in time and/or space may be successfully fused against the present invention event model, but at a lower confidence level. In the following section the unique features of the present invention designed to support reasoning over uncertain data in a CEP framework.

### Activity Pattern Learning

Another aspect of the present invention is its ability to discover predictive analytical models. According to one embodiment of the present invention an activity pattern leaning module can, based on the inputted inquiry, discover a pattern of events (and associated descriptions) that would be indicative a certain outcome.

The learning and discovery process begins with the assumption that relevant data sources have been identified and mapped into a data access layer such as a web enabled temporal analysis system Data Access Component (DAC) or other data access mechanism when using Semantic Web structures. A user then identifies or defines one or more learning contexts including region(s) of interest, timeframe(s) of interest, and event classes of interest (default values may be used here). For example, if a user is interested in developing a model to help predict failures of large water pumps (>500 gallons/minute) used in battling a wildfire, the present invention can, in one embodiment, constrain the spatial region surrounding the event, the timeframe to correspond with the fire outbreak and full containment, and identify pumps, water sources, crew types, terrain, weather, and water sources as classes of interest.

With certain constraints developed a user then defines or describes the event of interest (EOI) for the model being developed. The EOI may be defined using one of several techniques, including English description, a query developed using a query editing tool, a combination of date/time and geospatial coordinates for EOIs with no direct observables, and the like.

According to one embodiment of the present invention, the system thereafter compiles from the previously identified data sources a collection of observables that appear to be correlated with the defined EOI and that satisfy the defined contextual requirements. For each EOI in the data collected, the system constructs a training case containing observables that appear to correlate with that EOI.

Using visualization tools, the user may review each training case and decide to include or exclude it from further consideration. This allows users to eliminate training cases that may not be operationally relevant, such as cases involving known training activities or cases that may incomplete.

With a training case constructed, the present invention mines data for each observable to discover “predictive indicators”, event descriptions such as the one shown in the accompanying Figures, that appear to provide statistically significant correlation with the EOI. Note however that event descriptions at this stage lack context variables including those used to describe relative temporal constraints as no model structure has yet been determined.

Depending on the level of user involvement, the user may elect to review and revise system nominated indicators and/or nominate additional indicators for system refinement.

The system of the present invention then uses a form of Granger Causality to structure the events into a DAG where temporal ordering and statistical correlation are used to determine how the nodes are structured to form a working model. Temporal offsets and Fuzzy membership functions are also inserted into the model at this time as well as learning probability tables for each node. Lastly a user reviews and revises the model created prior to implementation.

In this manner the present invention provides a means by which to historically and forensically mine data to arrive at series of events that is predictive of a outcome of interest. The targeted inquiry can be wide ranging such as, for example, the failure of a critical water pump, the loss of a transmission in an ore truck, the launch of a surface-to-air missile, or the fraudulent use of a credit card. With access to a data source possessing pertinent information and a focused inquiry the present system can develop an activity pattern of observed events that leads to a useful and relevant determination.

### Uncertainty Management

The present invention addresses and embraces data uncertainty. As shown above, the present invention crafts a model or event pattern based on a number of observed events. Each event is determined to have occurred by a set of evidence descriptions or constraints. But, as has been discussed the occurrence of any one of those occurrences may be uncertain. Uncertainty in event processing comes from a variety of sources:

Sensor accuracy. For example, radar systems often report entity locations in terms of containment ellipses where the probability that the ellipse contains the actual location of the entity is some specified value, usually 90 or 95%. Other examples include sensors that report values of the form x±y indicating the presence of an underlying probability distribution for the reported data. Sensors possess varying degrees of accuracy. The present invention compensates for the uncertainty of collected data.

Source trustworthiness. Human Intelligence or “HUMINT” data is notoriously rife with inaccuracies or falsehoods. Even for “good” sources, the data they report may only be correct 50% of the time. Similarly, text extractors may extract only 80-90% of entities correctly, introducing a type of extraction uncertainty. These types of uncertainty are, according to one embodiment of the present invention, addressed by the underlying CEP engine and any associated reasoning components.

Information decay. For dynamical systems it is important to recognize and model state changes. However, it is equally important to support information decay. That is how the reliability or confidence in the data changes over time. While some entity attributes are immutable (e.g., the species of an animal), others may not only change over time but may change relatively rapidly, such as location of a moving vehicle. Because our confidence in observation data associated with mutable attributes wanes over time, the present invention provides explicit support for information decay, folding it into a comprehensive approach for addressing uncertainty.

Representing Uncertainty. The present invention also includes sophisticated techniques for representing and reasoning over uncertain data. One embodiment of the present invention takes advantage of these techniques by relying on a relational data model. Concepts such as information decay and confidence decay are much more difficult in the relational model. The following section describes one implementation technique according to the present invention of a Semantic Web-based data model.

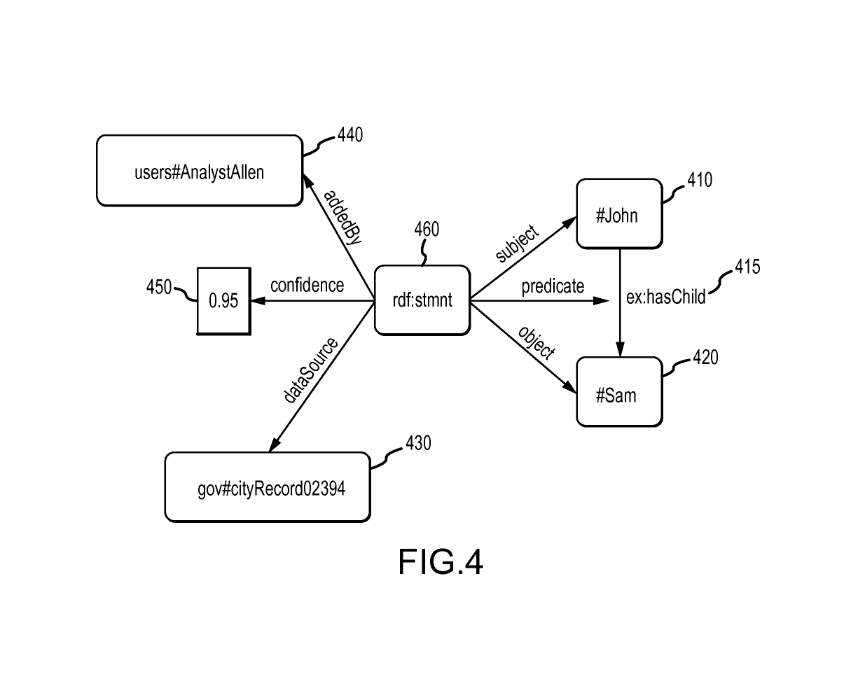

One way in which uncertainty is represented by the present invention is through the use of Semantic Web structures and reification: statements about statements. An example of Semantic Web Structure, according to one embodiment of the present invention, is shown in FIG. 4. FIG. 4 is a knowledge graph about a single triple relating to the relationship of Sam to his father John. As is well known in semantic web technology a triple includes a subject, predicate and object.

As shown, assertions have been made about a person John 410 (subject) having a child 415 (predicate) named Sam 420 (object). The reification of this statement 460 includes the source of this data 430 (a government record or database known as gov#cityRecord02394), the person making the assertion 440 (users#AnalystAllen), and the confidence 450 in the assertion itself (95%). Representing metadata in this form is part of the underlying Semantic Web technology on which the data model of the present invention is built. (The present invention also supports a non-Semantic Web data model. In that case, information decay and its role in discovering new information from existing uncertain data is more complex.) Through the form of representation shown in FIG. 4, the present invention effectively addresses both source trustworthiness and extraction uncertainty, two important sources of uncertainty in CEP reasoning. A third major source of uncertainty, stale data, is also addressed by the present invention and is described subsequently.

Another aspect of the present invention is how to determine and use these types of knowledge graphs or associations and how to discover new associations. For example, continuing with the knowledge graph of FIG. 4, an additional graph can state that Mary has a son named Sam. Does that mean that Mary and John are married? While there is a possibility that could be correct, there are multiple promotions in which the answer to that inquiry is no. According to one embodiment of the present invention literature based discovery looks at the relationships of the use of language to arrive at new associations.

Literature based discovery (LBD) has been around since the 1980's when D. R. Swanson first defined LBD as a means to discover previously unknown knowledge by examining term occurrences across multiple documents. LBD is the discovery of hidden knowledge in large sets of documents (data) where the discoveries relate, for example, concepts A and C together. In LBD, a single document in the corpus will not contain the discovery. Sometimes a linking term, B, may be the means by which a relationship between A and C is discovered and B would be in all documents containing A or C. In statistical approaches to LBD, there may not be a linking B term in the discovery. Instead, A and C are discovered by semantic relatedness of the documents using, for example, Latent Semantic Analysis (LSA) techniques. Once candidate discoveries are found, experiments may be performed to prove or disprove the hypotheses.

One aspect of the present invention is to use LBD to discover previously unknown related concepts using semantic vectors. In one embodiment of the present invention, a graphical database is used as a visualization tool that can assist in finding otherwise unrealized related concepts using multiple data domains.

LSA does not require, necessarily, a vocabulary, but, instead, finds similar documents or other data sources based on latent semantic indexing (LSI). LSA assumes that if terms or concepts are found in similar sets of text (not always the same text), then these terms or concepts may be related to the same or similar concepts. The mathematics behind LSI uses singular value decomposition (SVD) to reduce the dimensions of extremely large matrices by getting rid of less interesting data and to discover the related terms in documents. LSI proves to be more efficient than previous methods and is moderately successful, however, it is still slow and computationally expensive.

Random indexing (RI) is a more scalable version of LSI. RI has been extended to support indirect inference. Indirect inferences is sometimes referred to as LBD. RI uses a random approach to further reduce the size of matrices being analyzed so as to discover similar terms in documents. Instead of a full term by document matrix, documents are placed into small sets of columns. For example, if there are 10,000 documents, a document may be assigned to 20 randomly chosen columns. Each document's term frequency information is tallied in each of its columns, along with any other document that was randomly assigned. Variations on RI include—Sliding windows on RI, Term based Reflective Random Indexing (RRI), and Document based RRI. RRI uses RI but does it using results from one RI process and feeding it into another pass of RRI. Term and document based RRI vary how the random indexing is chosen by term or by document in various passes through the RRI. Presumably, these techniques provide more related terms/concepts that may not co-occur in the same document but are possibly related.

Semantic Vectors (SV) provides a library of capabilities that perform random indexing that performs much faster than SVD. SVD is an N×N problem where matrices will get to a size that current computing capabilities will now allow them to be computed. By comparison, RI can do LSA-like analysis on millions of documents.

A related product is a set of libraries that, among other things, allows for the searching of terms and phrases in sets of text documents or other representations of text like PDF's, HTML, word processing documents, etc. Such a product creates index files that contain the necessary information to not only find terms or phases quickly that may be contained in a corpus, it also is able to indicate where in the document the terms or phrases are. In the LBD solution of the present invention, indexes are created first and then a Semantic Vectors package is used to find candidate LBD pairs. Once pairs are found, the indexes are again referenced to find the documents in which entities are mentioned. From documents that mention candidate LBD pairs, relationship extraction is done to provide an even more clear reason as to why the concepts are related. For example, Mary may be married to John.

According to one embodiment of the present invention, the process of doing LBD discovers pairs of concepts that may be related and thus used in the development of the evidence descriptions. For example, a graph database representing node X, node Y and the link joining node X and Y is a good choice for storing results of SV or any other results of latent semantic analysis.

According to one embodiment of the present invention nodes are the concepts (for example, A, B and C concepts) and the links are either an LBD link where the nodes on either side of the link are never mentioned in the same document or a shared document link where the nodes on either side are both mentioned in one or more documents.

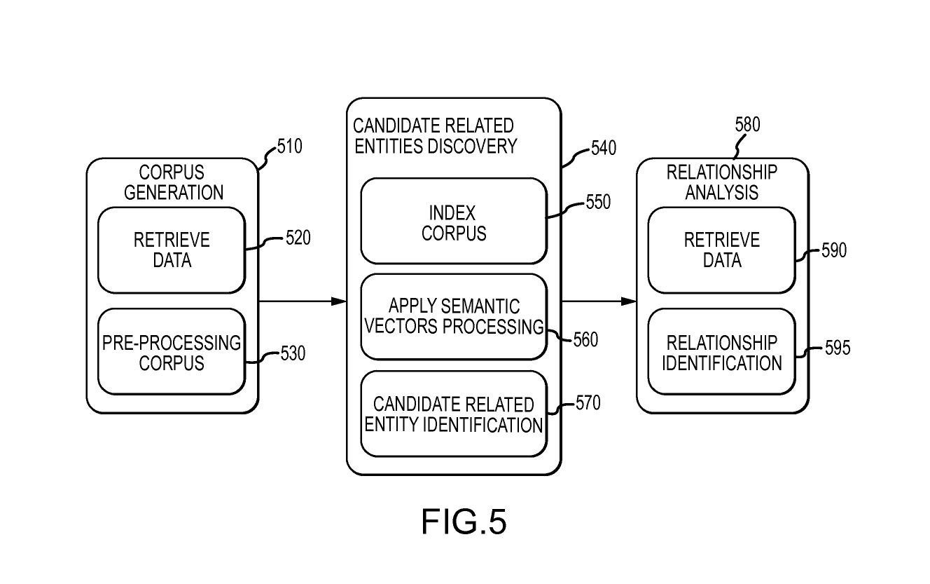

FIG. 5 provides a high level depiction of a system for LBD according to the present invention. A corpus 510 is generated in which data is stored. Once data is stored in a database, the data is visualized 530 in order to assist in the analysis of results. According to one embodiment of the present invention, a graph visualization tool is used. With a database loaded into a graph visualization tool, only LBD relationships (links) can be isolated or a tool can be used to show only shared common relationships.

When data on which LBD will be performed is stored in databases, a system is used to query and retrieve the data that is then written to the filesystem—one file per document. Such a system accesses data from any traditional relational database like SQLServer, Oracle, etc., as well as being able to access many other sources of data—such as file system data, live streams of data, and web services.

As an example, Web pages, news feeds and other open source data relating to Mexican drug cartels and their conflicts has been harvested and placed into a database in order to provide a realistic test bed for the present invention. When used in conjunction with the LBD system of the present invention, the contents of the articles are retrieved from the database using a data retrieval tool and copied to file system with one file per article.

There are multiple steps performed that ultimately present pairs of entities that may be related and presents candidate linking terms. For example, John and Sam, Mary and Sam, John and Mary. According to one embodiment of the present invention, the first step is to retrieve data 520 and place each document into a separate text file on the computer file system 540. The data in this example includes reports summarizing news articles, web pages or other sources of data (the cartel data), including databases with copies of emails. Alternatively, large XML files are broken up to get text documents suitable for analysis. Next, the corpus is used to identify the concepts that are desired to be analyzed (i.e. the A and C concepts). This makes a copy of the original file system documents and tags the new documents as necessary.

Then the corpus is indexed 550 creating multiple index files using, among other things, the semantic vectors package. The SV package builds 560 SV vector files. With the files in place, semantic vector processing occurs to create documents and term vector files. Candidate related entities are identified 570 by comparing the term vectors for each entity. These related entities are analyzed 580 by first retrieving 590 all the documents that mention either of the entities. At this time, identification of LBD candidates is done by finding the pairs of related entities that are never mentioned in the same documents. Then a determination 595 of why the entities may be related is conduced by a) examining documents where entities appear together and, b) when entities are LBD candidates, identify candidate linking B terms. This is done, according to one embodiment, by navigating the graph looking for terms that are linked to both the A and the C terms. After candidate A, B and C concepts, or just A and C concepts, are discovered, the documents mentioning A and C that is a subset of original corpus is examined to discover relationships between A and C and, if found, between A and B and B and C. This relationship reason discovery is done using relation extraction techniques, including conditional random fields (CRF).

Various embodiments of the present invention present an approach to discovering hidden knowledge in documents using a latent semantic analysis variant from the semantic vectors package. The approach discovers candidate A and C concepts or terms which, although never mentioned in the same document, may be related. Furthermore, the present invention discovers candidate linking or B terms that relate the A and C. This system will provide the platform on which alternative approaches can be tried to improve the quality of the discovered pairs.

Finally, the present invention addresses open LBD where the C concepts are not known. Such an analysis starts with a set of A concepts to study and the system discovers any candidate C concept that makes sense. All of these techniques can be used to make the observation of an event occurrence more reliable and robust.

### Information Decay.

As mentioned before, a fundamental nature of dynamical systems is change. Entities come into and out of existence (birth/death, creation/destruction, etc.), evolve, move, or otherwise experience change. When large enough timeframes are used, almost everything undergoes some sort of change. Various sensor technology has been designed to observe and measure entities in dynamical systems. However, even those sensors with rapid refresh rates still suffer somewhat from observation lag: the period of time between successive observations. For some sensors, this lag may be substantial. For example, consider an Electronic Intelligence “ELINT” sensor that detects the use of a high value individual's (HVI's) cell phone, through which the geo-spatial location of that HVI is inferred. After the call or after the ELINT sensor loses track (whichever occurs first), confidence in the location of that HVI begins to diminish, potentially at a rate much different than those for other attributes of that HVI such as his or her known associates, affiliations, or their gender. To properly support CEP processing of the present invention over dynamical systems, a method for addressing information decay must be taken into consideration.

In support of information decay, the data model used in one embodiment of the present invention includes both an asserted confidence, (the confidence in the assertion at the time the assertion was made), and a computed decayed confidence (the confidence in the assertion at the time the assertion was read and processed by the fusion engine). For example, we may get a report on the location of a vehicle of interest at time t, but the event model using that data may not need the vehicle's location until time t+δt. Our confidence in the location data should decay as the vehicle could have moved during the time δt. To support information decay, the data management component of the present invention framework provides explicit support for confidence decay based on the type of attribute and entity involved.

When used to support data fusion, the present invention uses the decayed confidence values of relevant assertions, combining them with their fuzzy correlation scores (a measure of how well the observation data satisfied the constraints of the event model against which the data is being fused), to determine an overall measure as to the likelihood of occurrence of the event in question.

A second, related concept involves discovery of implicit information from existing, uncertain data. For example, if in FIG. 4, Sam had a child Susan with confidence 99%, we could infer that John had a grandchild Susan. However, the grandchild assertion itself would be based on uncertain data and as such must itself be considered uncertain. In the data model of the present invention, an asserted confidence for this grandchild assertion can be computed from the decayed confidence values for the assertions in discovering the new information. In this case, the decayed confidence that Sam has child and that Sam is the child of John.

In this simple case the asserted confidence of the grandchild relationship would be the product of the decayed confidence values for the two has-Child relationships involved. This computed confidence value would become the asserted confidence value for this new relationship. Both the explicit support for information decay and its use in determining confidence values for derived information are included in the present invention.

### Fuzzy Fusion

Consider, once again, the event description shown in FIG. 2 and evidence description of FIG. 3. Suppose for a moment the event included a report of a hostile emitter (radar) in “HF” mode, that was just outside the 2ND Sector region by only a few meters and which these signals were observed 3.5 minutes after the communications event referenced in the event description (6 seconds earlier than expected). Although very close to the data expected by the constraints for this event, this observation nonetheless fails to explicitly satisfy this event's constraints: the emitter is not inside the named region and it was active too early to fully satisfy the constraints of this event model. The CEP engines of the prior art will fail to fuse this observation against this event description (assuming all other model constraints are satisfied). The present invention, however, successfully fuses these types of observation data against event descriptions using a form of fuzzy fusion. One or more embodiments of the present invention support temporal, spatial, and set membership fuzzy fusion, as well as other types of fuzzy fusion such as entity-based, property-based, or relationship-based fusions as described herein.

### Temporal Fuzziness

Within the present invention model, temporal constraints may be used to define when an event is expected to be observed. There are two types of temporal constraint; relative and absolute.

Relative.

As their name implies, relative temporal constraints define an event's expected timeframe of occurrence relative to some temporal anchor, be it the session window (the period of time from which observation data may be drawn and fused against a model) or relative to some other event described in the model. The first type of anchors are denoted as “anytime” constraints; typically they are used to denote event correlations without defining a timeframe for the occurrence of those events. As a simple example, a nail in a tire may eventually cause the tire to run flat, but there may not necessarily be a defined time line between the nail and the flat other than the nail preceding the flat. In this case, we may use an anytime relationship from the nail event to the flat tire event indicating event sequencing and dependency without defining a specific timeframe between those two events. The second type of relative temporal constraint is shown in the event description of FIG. 2. As can be seen in the figure, occurrence of the emitter event 240 is expected to occur some number of minutes after either the event Com_{—}3 225 or the event Air_{—}2 230. This type of relative constraint helps to not only establish event sequencing, but also identifies event timing as well.

Absolute.

This type of event temporal event is not relative to any other time anchor but instead references specific points in time, such as Thursdays at 1423Z. While these types of temporal constraints may be less common than relative temporal constraints, they nonetheless are useful in describing events that are known to occur or should occur at specific times.

One aspect of the present invention is the use of sophisticated temporal reasoning to determine when various events in an activity model could or should be expected to occur. This reasoning can be used to cue analysts to upcoming significant events in their region of interest.

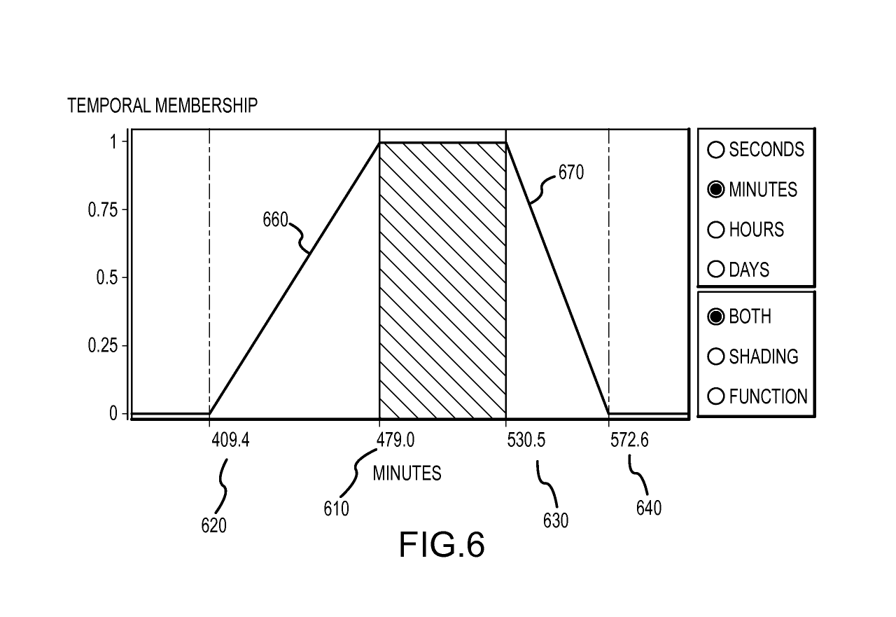

A graphical depiction of a relative temporal constraint, according to one embodiment of the present invention, is shown in FIG. 6. For the constraint depicted in FIG. 6, the event in question (not shown) is expected to occur no earlier than 479 minutes 610 and no later than 530.5 minutes 630 after the referent preceding event (not shown). If the event in question occurs within this relative timeframe, its occurrence will be considered “on-time” and the temporal constraint will be fully satisfied. However, if the event in question occurs either earlier or later, the fuzzy membership function 660, 670 depicted in the figure describes how to interpret “on-time” for this event. For this event, occurrence before 409.4 minutes 620 after the referent event is considered “too early” to match while occurrence later than 572.6 minutes 640 after the referent event is too late to match. Note that the membership function need not be symmetric. Definition of these relative temporal constraint fuzzy membership functions is under user control.

Formally speaking, μA (x) is called the membership degree of the argument x in the fuzzy set A. In one or more embodiments of the present invention, A denotes relative temporal offsets (a time delta) between two events, a preceding referent event, and the event to which the constraint applies. By defining the range of μA (x) to be {0, 1} rather than the range [0, 1], we can effectively define non-fuzzy or crisp temporal offsets between pairs of events.

### Spatial Fuzziness

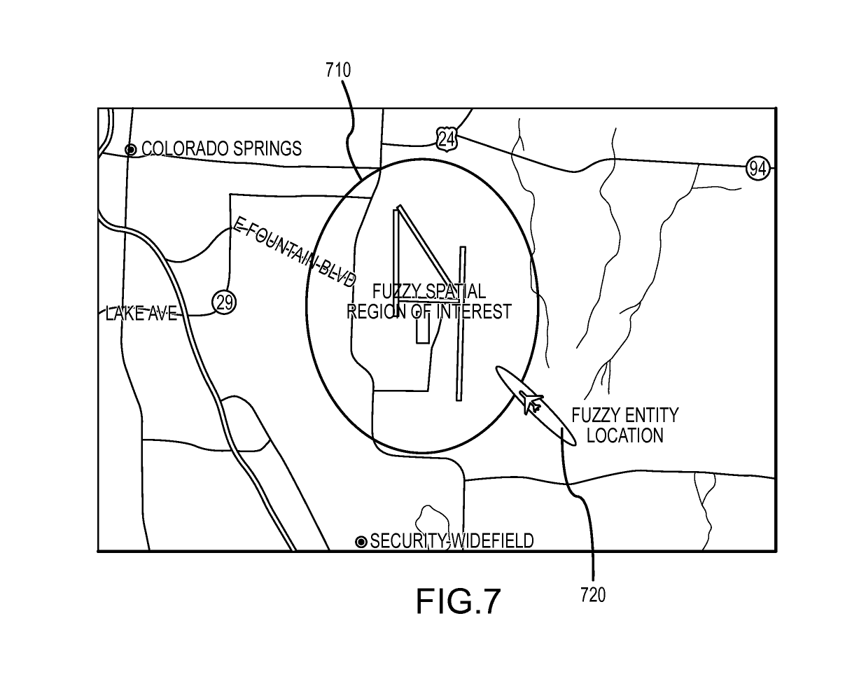

Similar in nature to temporal fuzziness, the present invention supports fusion of observation data involving entities with fuzzy geographic extent. This is shown graphically in FIG. 7 where a region of interest 710 has been defined using a fuzzy boundary and an entity with a fuzzily defined location 720 has been observed. The present invention can successfully process these types of fuzzy region overlap using fuzzy logic.

Many entities detected by remote sensors have locations that are reported in error ellipse form 720: a center location, a major and minor axis length, and a degree of rotation from horizontal. Most CEP engines use only the center location when determining whether the entity is inside (outside) a region. However, one or more embodiments of the present invention are able to point locations, and/or locations reported in error ellipse form, to determine fuzzy membership values for various spatial constraints such as “inside,” “outside,” or “overlaps.” For example, letting A denote the fuzzy membership function for region A and B denote the fuzzy membership function for region B, the degree to which A overlaps B is given by

overlaps(A,B)=sup_{xεX}T_{W}(A(x),B(x))

where

T_{W}(a,b)=max(0,a+b−1)

Similar to fuzzy temporal constraints, the present invention provides model developers the ability to control the extent of a constraint's fuzzy spatial boundaries.

### Fuzzy Scoring and Bayesian Reasoning

The use of fuzzy fusion requires the ability to combine fuzzy correlation scores across event constraints within event descriptions and requires techniques for combining those scores with the underlying Bayesian Network used to propagate probabilities for as-yet unobserved events in a model. To combine fuzzy scores within a given event description, the present invention uses, in one embodiment, standard fuzzy logic. This defines a fuzzy membership function for the event description describing the degree to which the observational evidence satisfies the event description, or in other words, the degree to which the event is judged to have occurred. The present invention folds these scores into the predictive Bayesian Network used to support probabilistic reasoning. Thus, in the present invention, the occurrence of an event is not limited to “not occurred” (0) or “occurred” (1), but instead spans a range [0, 1] corresponding to observations spanning “not observed” to “observed.” These fuzzy values are then folded into the underlying Bayesian Network in support of probabilistic reasoning. To do so, the present invention makes use of Pearl's virtual evidence technique.

Pearl's technique allows one to account for “soft” evidence. For example, suppose we receive information from a sensor that it is 95% likely that event b has occurred. That is, for evidence e, we have P (e|b)=0.95. Assuming the false positive and false negative rates are the same for this sensor, we can define a virtual evidence node that has the following truth table (Differing false positive and false negative rates can be addressed by making appropriate modification to the truth table):

| B | e | not_e |
|---|---|---|
| b | 0.95 | 0.05 |
| not_b | 0.05 | 0.95 |

A BN node with this probability table can then be conceptually attached to the node B with B as the parent. Asserting the evidence (i.e., asserting that e is true) has the effect of propagating the uncertainty associated with the occurrence of event B through the belief network. The present invention uses this technique to support integration of fuzzily fused observation data. Specifically, the fuzzy correlation score for evidence e against event description B is interpreted to be P (e|B). This enables the present invention to operate across event occurrence values from definitely not observed to definitely observed, and everything in between.

Another aspect of the present invention is its ability to leverage the concept of context propagation from Augmented Transition Networks (ATNs). Specifically, the present invention supports the specification of event models that reference variables whose values are established by preceding nodes in the network. These evidence variables take the form $(Node name. attribute) where Node name identifies the event node that defines and establishes the value of the referenced entity while the attribute delimiter identifies the specific attribute. Note that the attribute field may be more than one level deep. For example, the evidence variable$(Air2.Positions.Time) references the time attribute of the positions attribute of the entity defined in the node Air2. For this domain, the present invention interprets this reference to mean the earliest posit (position-time pairing) for the Air2 entity. A common usage of this type of context propagation is illustrated by the relative temporal constraints of the event description of FIG. 3. However, evidence variables may also be used to ensure the same entity is participating in a model's events.

For example, a model could be developed containing an event description designed to detect a convoy departure from a region of interest, while a subsequent event description in that model is designed to detect entry of that convoy into another region of interest. In this case an evidence variable may be used to ensure that the convoy matching the earlier event is the same convoy used to match the latter event. Evidence variables help reduce false positive rates; in the preceding example, without evidence variables the fusion engine could use two separate convoys as supporting evidence, one that left the first region of interest and a second that entered the second region of interest. The present invention's use of evidence variables not only provides support for establishing relative temporal offsets between subsequent events, they also enable the definition of models designed to describe complex interactions of entities over time and space.

### Dynamic Systems and Cross-Temporal Consistency

Knowledge representation for dynamic systems are also addressed by the present invention. Entity attributes that change over time (including entity birth and death) are often reported and recorded using some variant of entity, attribute, value, timestamp. The most recent timestamp records the most current attribute value for that entity. While this type of representation may work well for some knowledge representation schemes such as relational databases, it does not work as well for some emerging knowledge representation formalisms such as the Semantic Web.

As previously mentioned, in Semantic Web technologies, knowledge is represented in the form of <subject, predicate, object> triples as in #Joe isMarriedTo #Sarah. These triples are referred to as Resource Description Framework (RDF) triples. Predicates themselves can have semantic properties associated with them. For example, one could define isMarriedTo to be a functional (one-to-one) property and a sub-property of isRelatedTo. If Joe later divorces Sarah and marries Julie, we could assert #Joe isDivorcedFrom #Sarah and #Joe isMarriedTo #Julie. However, assertion of the latter triple leads to an inconsistency in the knowledge-base in that both #Joe isMarriedTo #Sarah and #Joe isMarriedTo #Julie have been asserted; since isMarriedTo was defined to be a functional property, using Semantic Web reasoning, either Sarah and Julie must be the same person (thereby satisfying the functional property of isMarriedTo) or an inconsistency exists. Adding temporal information to the assertions does not alleviate this problem.

While the present invention fusion engine itself is relatively agnostic to the underlying knowledge representation form (in one embodiment, the present invention is isolated from source data through its data access mechanism), other embodiments of the present invention are operable to function with Semantic Web data structures. A Semantic Web standards-based approach enables the consistent treatment of these types of fluent or dynamic properties. Specifically, the present invention uses proprietary standards-based techniques in which relevant observation data is ingested, converted into RDF form, enriched using formal reasoners and/or specialized Semantic Web query constructs designed to make implicit information explicit, and then fused by the present invention engine against event descriptions, all while preserving data consistency.

This solution is to partition observation data into named graphs (NGs), a formalism that can be used to associate metadata with an RDF graph. In this approach, the metadata associated with a graph identifies its validity interval: the interval of time during which the assertions in the associated graph are guaranteed to hold. By selecting and merging all named graphs whose validity intervals include a specified time t, the world state or knowledge base for time t can be created. As data is ingested, a series of consistency rules, along with default knowledge decay rates, are used to close validity intervals for existing NGs as appropriate. For example, we may have an NG containing the triple #Joe isMarriedTo #Sarah with a validity interval of (25 May 1986, ∞) indicating they were married 25 May 1986; the ∞ closing date indicates an assumption of permanence for that data. When Joe and Sarah divorce, the validity interval is closed and another NG is created containing the updated information. The table below depicts an example of this data representation.

To find the world state on, say 16 Aug. 2011, we merge the NGs whose validity intervals include 16 Aug. 2011 to find #Joe isDivorcedFrom #Sarah and #Joe isMarriedTo #Julie from the merger of graphs G1 and G2. Note that the information in G1 was not used because the information in G1 was invalid for the given query date.
Joe marries Sarah on May 25, 1986:
G1: #Joe isMarriedTo #Sarah (25 May 1986, ∞)←—Assume permanence
Joe and Sarah divorce on Jul. 26, 2002:
G1: #Joe isMarriedTo #Sarah (25 May 1986, 26 Jul. 2002)←Note validity interval update
G2: #Joe isDivorcedFrom #Sarah (26 Jul. 2002, ∞)
After Joe marries Julie on Sep. 4, 2008:
G1: #Joe isMarriedTo #Sarah (25 May 1986, 26 Jul. 2002)
G2: #Joe isDivorcedFrom #Sarah (26 Jul. 2002, ∞)
G3: #Joe isMarriedTo #Julie (4 Sep. 2008, ∞)

The above representation provides a Semantic Web standards based approach for representing and reasoning over dynamic (fluent) data in a consistency-preserving manner.

Disclosed herein are features of the present invention that provide a unique ability to successfully represent, reason over, and fuse noisy, uncertain data against truly complex event models and to use the results of that fusion to support predictive analysis as to the likelihood of future events or the likelihood of events that may have occurred but were just not detected or recorded in the data stream. Other embodiments include techniques supporting submodels, model families, and models with latent events in which event occurrence cannot be directly observed.

For complex domains, it may be the case that several pieces of disparate evidence could match an event description. For example, consider an event description looking for a black truck leaving a parking lot during a given timeframe. For a large lot, several vehicles exiting the lot could match that event description at varying degrees of satisfaction. Rather than selecting the first piece of matching evidence or the piece of evidence with the highest correlation score, the present invention uses multiple hypotheses, one for each piece of matching evidence. Future evidence will then be fused against one or more of these hypotheses as appropriate.

Another version of the present invention involves making the data source independent. While the invention retains the ability will be compatible with structured data sources, in another embodiment, it can run independently from an unstructured data sources enabling customers to install a lighter weight version of the software if desired.

Through the use of Groovy scripts, in one embodiment of the present invention, models have the ability to execute custom business rules/logic as models are activated. Typically, this feature has been used to support generation and distribution of alerts and notifications as evidence is fused against models. Lately, however, it has become desirable to associate action scripting at the event level as well. This would support, for example, applying data transforms to data fused against an event so that the transformed data may be referenced elsewhere in the model. One aspect of the present invention extends the use of fuzzy membership functions (FMFs), as well as extending the fuzzy fusion process to include entity and relationship fuzzification. For example, an event description may be defined in which a hasDaughter relationship is needed between two actors mentioned in the constraint, such as #p1 hasDaughter #d1. However, due to uncertainty in the observation data, we may instead only have a pair of entities that may satisfy other constraints in the event description but for which a weaker hasChild relationship holds. In this case, it could be useful to match these data but at a lower confidence level, similar to the way that spatial and temporal data may be matched.

The existing combination of unique features and emerging capabilities described herein make the present invention fuzzy CEP engine uniquely qualified to support a wide variety of domains ranging from closed domains with noiseless data to domains with noisy, uncertain multi-source data.

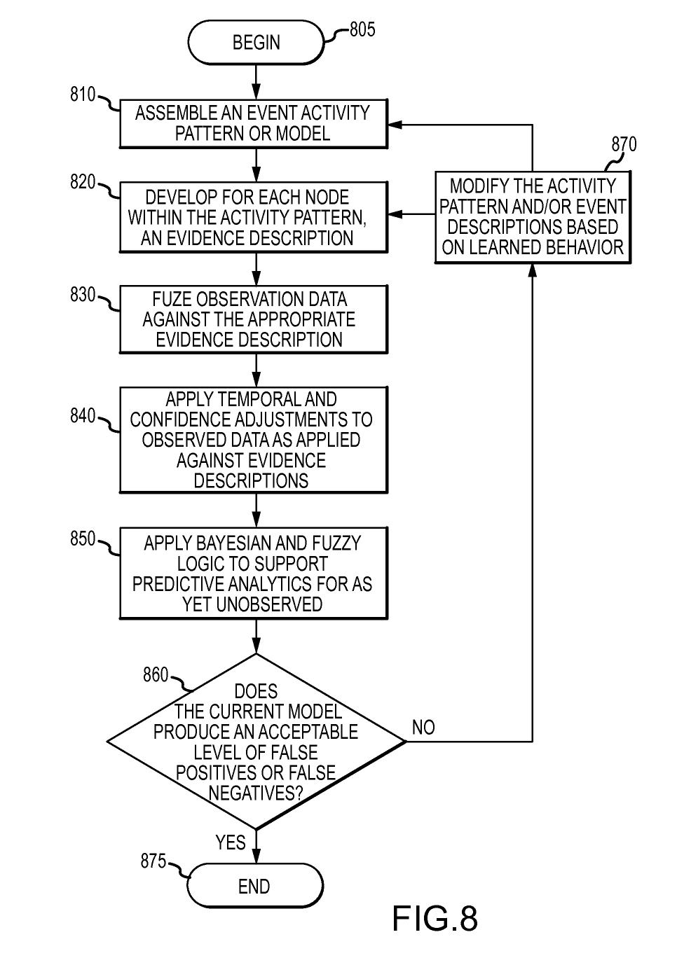

FIG. 8 presents a flowchart of one method embodiment of a temporally predictive analytic system of the present invention. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

The methodology shown in FIG. 8 begins 805 with the assembly 810 of an event activity pattern or model. As has been described herein, the construction of such a model can be based on historical or forensic data by a technician familiar with the events generally leading up to a particular outcome or, in one embodiment, the system of the present invention can compile definitive events that, based on observations of disparate data, lead to desires analytical outcome.

With the event pattern developed the next step turns to the development of an evidence description 820 for each node (event) within the activity pattern. For each node, one or more observation qualifiers or examinations is formed to determine the likelihood that evidence supports the conclusion that an event has occurred. Observation data is fuzed 830 against each qualifier in the evidence description, including any temporal constraints.

The present invention applies temporal and confidence level adjustments 840 to provide the temporal predictive analytical system of the present invention to consider events that are not black and white but rather occurred late or early or that confidence of the data is simply suspect. This process continues by applying Bayesian and Fuzzy logic 850 to support predictive analytics for those events that have yet to be observed.

Before concluding 895, the present system considers the model and evidence description and asks 860 whether the model and/or individual evidence descriptions are properly crafted. If there is an unacceptable level of false positives/false negatives from the overall model or one or more individual events the present system is operable to adjust or modify 870 the activity model and/or individual evidence descriptions to arrive at useful temporal predictive analytical tool.

A fuzzy complex event processing (CEP) system operable to process noisy, incomplete, multi-source data in support of near real-time decision-making has been described herein. The fuzzy CEP solution of the present invention supports decision-making by identifying and exploiting patterns hidden in complex data and can operate in a forensic mode against historical data, near real-time mode for proactive decision-making, or any combination thereof. Fusion algorithms and techniques are applied to observation data that may only partially satisfy an event description in time, space, or other relevant dimensions. Using context propagation, Bayesian reasoning, and spatiotemporal analysis, the present invention provides both predictive awareness of upcoming events and likelihood analysis for events that may have already occurred, but were not evident in the collected data, while at the same time minimizing false detections.

It will be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

In a preferred embodiment, the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

An exemplary system for implementing the invention includes a general purpose computing device such as the form of a conventional personal computer, a personal communication device or the like, including a processing unit, a system memory, and a system bus that couples various system components, including the system memory to the processing unit. The system bus may be any of several types of bus structures including a memory bus or memory controller, a peripheral bus, and a local bus using any of a variety of bus architectures. The system memory generally includes read-only memory (ROM) and random access memory (RAM). A basic input/output system (BIOS), containing the basic routines that help to transfer information between elements within the personal computer, such as during start-up, is stored in ROM. The personal computer may further include a hard disk drive for reading from and writing to a hard disk, a magnetic disk drive for reading from or writing to a removable magnetic disk. The hard disk drive and magnetic disk drive are connected to the system bus by a hard disk drive interface and a magnetic disk drive interface, respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer may also be used in the exemplary operating environment.

Embodiments of the present invention as have been herein described may be implemented with reference to various wireless networks and their associated communication devices. Networks can also include mainframe computers or servers, such as a gateway computer or application server (which may access a data repository). A gateway computer serves as a point of entry into each network. The gateway may be coupled to another network by means of a communications link. The gateway may also be directly coupled to one or more devices using a communications link. Further, the gateway may be indirectly coupled to one or more devices. The gateway computer may also be coupled to a storage device such as data repository.

An implementation of the present invention may also be executed in a Web environment, where software installation packages are downloaded using a protocol such as the HyperText Transfer Protocol (HTTP) from a Web server to one or more target computers (devices, objects) that are connected through the Internet. Alternatively, an implementation of the present invention may be executing in other non-Web networking environments (using the Internet, a corporate intranet or extranet, or any other network) where software packages are distributed for installation using techniques such as Remote Method Invocation (“RMI”) or Common Object Request Broker Architecture (“CORBA”). Configurations for the environment include a client/server network, as well as a multi-tier environment. Furthermore, it may happen that the client and server of a particular installation both reside in the same physical device, in which case a network connection is not required. (Thus, a potential target system being interrogated may be the local device on which an implementation of the present invention is implemented.)

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

1. A system for temporal predictive analytics, comprising:
an event activity pattern wherein the event activity pattern includes one or more precursory events associated with an initial inquiry; and
an evidence description for each of the one or more precursory events wherein each evidence description includes one or more evidentiary conditions collectively forming an assessment as to a likelihood that the precursory event has been observed and wherein each of the one or more evidentiary conditions includes a measure of confidence.

2. The system for temporal predictive analytics according to claim 1, wherein the assessment of the likelihood that the precursory event has been observed is based on a fuzzy logic combination of the measure of confidence of each evidentiary condition.

3. The system for temporal predictive analytics according to claim 1, wherein the measure of confidence includes sensor accuracy.

4. The system for temporal predictive analytics according to claim 1, wherein the measure of confidence includes data extraction accuracy.

5. The system for temporal predictive analytics according to claim 1, wherein the measure of confidence includes information decay.

6. The system for temporal predictive analytics according to claim 5, wherein information decay includes an asserted confidence.

7. The system for temporal predictive analytics according to claim 5, wherein information decay includes a computed decayed confidence.

8. The system for temporal predictive analytics according to claim 1, wherein the assessment of the likelihood that the precursory event has been observed includes discovery of implicit information from existing uncertain data.

9. The system for temporal predictive analytics according to claim 1, wherein the evidence description includes one or more temporal conditions.

10. The system for temporal predictive analytics according to claim 9, wherein the one or more temporal conditions are fuzzy temporal constraints.

11. The system for temporal predictive analytics according to claim 10, wherein the assessment of the likelihood that the precursory event has been observed is based on a combination of a measure of confidence of each evidentiary condition and each fuzzy temporal constraint.

12. The system for temporal predictive analytics according to claim 1, wherein the assessment of the likelihood that each precursory event has been observed is combined with Bayesian reasoning to propagate probabilities for yet-to-be observed precursory events in the event activity model.

13. The system for temporal predictive analytics according to claim 1, wherein the event activity pattern includes context propagation.

14. A method for temporal predictive analytics, comprising:
forming an event activity pattern wherein the event activity pattern includes one or more precursory events associated with an initial inquiry;
describing, for each of the one or more precursory events, one or more evidentiary conditions collectively wherein each of the one or more evidentiary conditions includes when available a measure of confidence; and
forming an assessment as to a likelihood that the precursory event has been observed.

15. The method for temporal predictive analytics according to claim 14, wherein describing includes autonomously identifying the one or more evidentiary conditions from among a collection of possible forensic explanations of the one or more precursory event.

16. The method for temporal predictive analytics according to claim 14, further comprising combining the measure of confidence of the one or more evidentiary conditions based on fuzzy logic to arrive at the assessment as to the likelihood that the precursory event has been observed.

17. The method for temporal predictive analytics according to claim 14, further comprising propagating probabilities to yet-to-be observed precursory events using Bayesian reasoning.

18. The method for temporal predictive analytics according to claim 14, further comprising referencing variables in a precursory event whose value has been established by a preceding precursory event.

19. The method for temporal predictive analytics according to claim 14, wherein describing includes, for each of the one or more precursory events, one or more fuzzy temporal constraints.

20. The method for temporal predictive analytics according to claim 19, wherein the assessment of the likelihood that the precursory event has been observed is based on a combination of a measure of confidence of each evidentiary condition and each fuzzy temporal, spatial, entity or entity relationship constraint.

21. The method for temporal predictive analytics according to claim 14 wherein diverse data sets can be mined for predictive indicators that are integrated into the event activity pattern using statistical and/or temporal correlations between those discovered events.

22. The method for temporal predictive analytics according to claim 14 wherein forming includes mining diverse data sets for predictive indicators that are assembled into the event activity pattern using statistical and/or temporal correlations between those discovered events.

23. A computer-readable storage medium tangibly embodying a program of instructions executable by a machine wherein said program of instruction comprises a plurality of program codes for temporal predictive analytics, said program of instruction comprising:
program code for forming an event activity pattern wherein the event activity pattern includes one or more precursory events associated with an initial inquiry;
program code for describing, for each of the one or more precursory events, one or more evidentiary conditions collectively wherein each of the one or more evidentiary conditions includes a measure of confidence; and
program code for forming an assessment as to a likelihood that the precursory event has been observed.

24. The computer-readable storage medium of claim 23, tangibly embodying a program of instructions, further comprising program code for combining the measure of confidence of the one or more evidentiary conditions based on fuzzy logic to arrive at the assessment as to the likelihood that the precursory event has been observed.

25. The computer-readable storage medium of claim 23, tangibly embodying a program of instructions, further comprising program code for propagating probabilities to yet-to-be observed precursory events using Bayesian reasoning.

26. The computer-readable storage medium of claim 23, tangibly embodying a program of instructions, further comprising program code for referencing variables in a precursory event whose value has been established by a preceding precursory event.

27. The computer-readable storage medium of claim 23, tangibly embodying a program of instructions, wherein the program code for describing includes, for each of the one or more precursory events, one or more fuzzy temporal constraints.

28. The computer-readable storage medium of claim 27, tangibly embodying a program of instructions, wherein the assessment of the likelihood that the precursory event has been observed is based on a combination of a measure of confidence of each evidentiary condition and each fuzzy temporal constraint.
